(19) United States
(12) Patent Application Publication
(10) Pub. No.: US 2008/0223665 A1
(43) Pub. Date: Sep. 18, 2008

(54) FLEXIBLE LOAD-BEARING MEMBER FOR ELEVATOR SYSTEM

(76) Inventor: Hugh O'Donnell, Longmeadow, MA (US)

Correspondence Address: O''SHEA GETZ P.C., 1500 MAIN ST. SUITE 912, SPRINGFIELD, MA, 01115, US

(21) Appl. No.: 12/044,424

(22) Filed: Mar. 7, 2008

Related U.S. Application Data
(60) Provisional application No. 60/894,990, filed on Mar. 15, 2007.

(51) Int. Cl. B66B 11/08

(52) U.S. Cl. 187/256

(57) ABSTRACT

A load-bearing member operable to be driven by a drive sheave in an elevator system is provided. The load-bearing member has a body defined by a thickness, a width that is greater than the thickness, and a length. The body comprises a single solid material that is uniform in the cross-section, and is sufficiently flexible to permit the member to wrap at least partially around the drive sheave of an elevator system. An elevator system is also provided that includes the aforesaid load-bearing members, a car, a counterweight and a drive sheave. The load-bearing members connect the car and counterweight to the drive sheave, and are wrapped at least partially around the drive sheave.

### CROSS-REFERENCE TO RELATED PATENT APPLICATIONS

This application claims the benefit of U.S. Provisional Patent Application No. 60/894,990 filed Mar. 15, 2007, which is incorporated by reference herein in its entirety.

### BACKGROUND OF THE INVENTION

1. Technical Field

This invention generally relates to elevator systems in general, and to flexible load-bearing members for supporting and propelling an elevator car relative to a drive sheave in particular.

2. Background Information

There are several known types of elevator systems. Traction-based systems typically include an elevator car and a counterweight and load-bearing members that support and connect the car and counterweight. The car is moved between various floors because of friction/traction between the load-bearing members and a drive sheave.

Historically, elevator systems have used “ropes” to extend between an elevator car and a drive sheave, and in some applications to a counterweight as well. The term “rope” is a term of art that typically refers to a generally circular member formed from a plurality of wound strands. Steel ropes, which consist of a plurality of wound steel fibers, are subject to corrosion, very high pressure, excessive wear, and premature failures. Recently other load-bearing members have been utilized, such as coated steel belts and fiber ropes. Disadvantages associated with coated steel belts include manufacturing costs, inability to visually inspect, possible traction problems, and possible degradation of the coating. Fiber ropes have ride quality issues (lower stiffness resulting in higher elongation), difficult inspection methodologies, very high-pressure and high wear rates.

It would, therefore, be beneficial to be able to provide an elevator system with a load-bearing member having one or more of improved corrosion resistance, inspectability, traction, and manufacturability.

### SUMMARY OF THE INVENTION

According to the present invention, a load-bearing member operable to be driven by a drive sheave in an elevator system is provided. The load-bearing member has a body defined by a thickness, a width that is greater than the thickness, and a length. The body comprises a single solid material that is uniform in the cross-section, and is sufficiently flexible to permit the member to wrap at least partially around the drive sheave of an elevator system.

According further to the present invention, an elevator system is provided. The elevator system includes a plurality of load-bearing members, a car, a counterweight and a drive sheave. Each load-bearing member has a body defined by a thickness, a width that is greater than the thickness, and a length. The body comprises a single solid material, and is uniform in the cross-section. The load-bearing members connect the car and counterweight to the drive sheave, and are wrapped at least partially around the drive sheave.

It is desirable to make elevator systems smaller and more reliable. The present invention facilitates making an elevator system size much smaller at a given system weight. All industrialized nations regulate elevator system design with specific strength and durability requirements. In particular, most countries specify that the ratio of the drive machine sheave diameter to the load-bearing member diameter/thickness (D/d) must be greater than or equal to 40:1. Hence, the rope/belt size necessary to support the load with an appropriate safety factor (e.g., ≧10) will dictate the drive sheave diameter. The drive sheave diameter, in turn, dictates the machine torque requirements and, therefore, the size of the driving motor. A large percentage of the cost of an elevator system is due to the size of the motor. The thin cross-section of the present invention load-bearing members permits the use of very small diameter drive sheaves, and related very small motors.

Because elevator systems typically operate with different weights attached to each end of the load-bearing members, there are different elongation characteristics between lightly loaded and heavily loaded sides. These differences, side to side, are accommodated as the load-bearing members pass over the driving sheave. There is also continual relative motion between the drive sheave and the load-bearing members, which is referred to as creep, and further relative motion caused by acceleration, deceleration, sudden stops, etc. The relative motion can cause wear on load-bearing members. To accommodate the relative motion, and thereby minimize the aforesaid wear, compliant, high friction coatings having a uniform thickness are applied to the grooves of the drive sheaves. An example of an acceptable high friction coating is castable polyurethane.

In most elevator systems, a plurality of load-bearing members is used. To keep the load-bearing members in alignment and in their correct groove positions, a positive crown (convex surface) can be utilized on each groove of the drive sheave. Each groove may have coated shoulders to prohibit contact between adjacent load-bearing members. Because of the need to control the elevator car even in the event of a fire, the drive sheave must possess adequate friction without the polyurethane coating. The groove surfaces can be roughened and hardened to provide the necessary friction and control of the car.

Another advantage of the present invention is that the load-bearing members can be made of corrosion resistant stainless steel that does not require periodic lubrication. Prior art steel wire ropes require lubrication. The ability of the present invention load-bearing members to operate without lubrication enables the present invention elevator systems to operate in a more environmentally favorable manner.

The exposed nature of the present invention load-bearing members facilitates periodic inspections. Coated steel belts and aramid fiber ropes include coatings that surround the strength members to retard abrasion and impart cohesion. These coatings create problems for periodic inspection and in some instances necessitate the use of monitoring equipment and specific inspection methodologies. In contrast, the present inventions load-bearing members are readily accessible for visual inspection and, if deemed necessary, can be inspected using dye penetrant inspection (DPI).

For those embodiments of the present invention that utilize stainless steel load-bearing members, after the useful life of the members is completed the stainless steel can be completely recycled. In contrast, oily steel ropes, coated steel belts, and coated fiber ropes have little or no recycle value and are typically discarded after their useful life is completed.

The foregoing and other objects, features and advantages of the present invention will become more apparent in light of the following drawings and detailed description of the present invention.

### BRIEF DESCRIPTION OF THE DRAWINGS

FIG. 1 diagrammatically illustrates a typical 2:1 elevator system configuration.

FIG. 2 diagrammatically illustrates an alternative elevator system configuration.

FIG. 3 is a diagrammatic perspective view of a flexible load-bearing strip in accordance with the present invention.

FIG. 4 is a diagrammatic partial view of a crowned sheave with a coating or sleeve, and a load-bearing member engaged with the sheave.

FIG. 5 is a diagrammatic cross-sectional view of a load-bearing member, including arcuate longitudinal edge surfaces.

FIG. 6 diagrammatically illustrates a traction sheave embodiment in accordance with the present invention.

FIG. 7 is a data table of exemplary flexible load-bearing strips and associated sheave data.

### DETAILED DESCRIPTION OF THE INVENTION

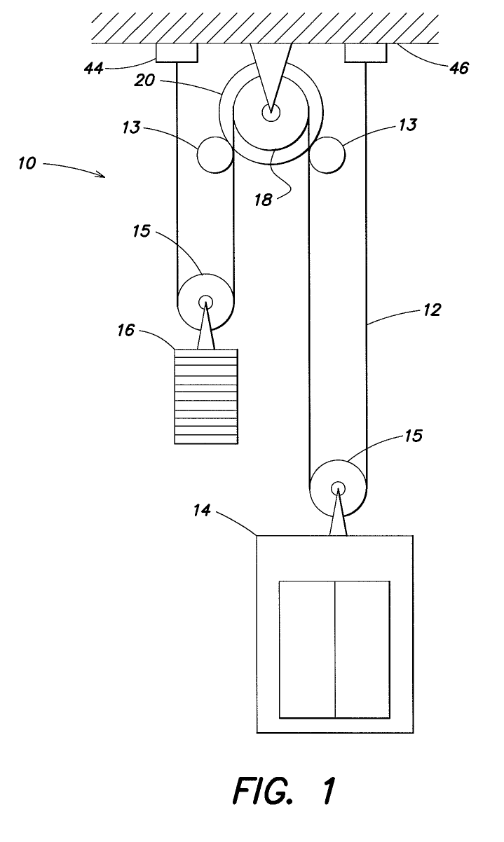

Now referring to FIG. 1, an elevator system 10 includes an elevator car 14 and a counterweight 16 is diagrammatically shown within a hoistway 46, connected to one another by one or more flexible load-bearing members 12. The load-bearing members 12 are shown extending in a 2:1 roping configuration, wherein the members 12 pass over a drive sheave 18, drop to the elevator car 14 or counterweight 16, and subsequently wrap around another unpowered sheave(s) 15 attached to the respective car 14 or counterweight 16 before returning to an anchor position 44 at the top of the hoistway 46. As will be detailed below, frictional engagement (i.e., traction) between the drive sheave 18 and load-bearing member 12 enables the drive sheave 18 to move the load-bearing member 12 and therefore the attached elevator car 14 and counterweight 16.

In a 2:1 system, the grooves of the sheaves 15, 18 are typically crowned for alignment purposes, as will be discussed below. The configuration of the sheaves 15, 18 will subject the load-bearing members 12 to reverse curvatures when the load-bearing members 12 engage the crowned sheaves 15, 18. To prevent mis-tracking as the load-bearing members 12 enter a sheave 18, it is known to use flat rollers 13 with low friction coating, which rollers 13 are positioned adjacent to the drive sheave 18 to reflatten the load-bearing members 12. The grooves of the unpowered sheaves 13 within the 2:1 system are typically coated with a durable, low friction material to prevent/minimize tension imbalance between the flat load-bearing members 12. Acceptable coating materials include polypropylene or polyethylene, or alternatively the entire sheave 13 can be made from high hardness Nylon with friction-reducing additives.

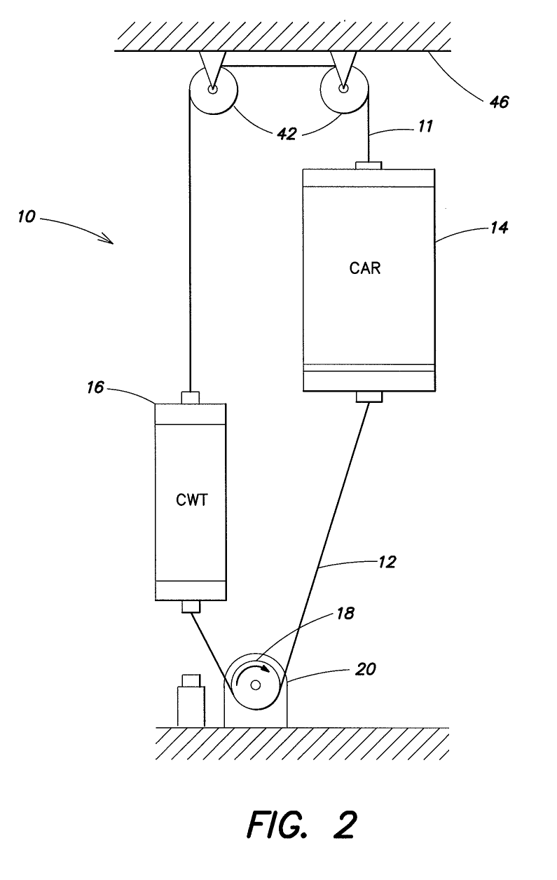

FIG. 2 diagrammatically illustrates another elevator system embodiment in which one or more load-bearing members 11 (e.g., a steel rope) extend between an elevator car 14 and a counterweight 16, passing at least partially around one or more non-powered sheaves 42 located at the top of the hoistway. One or more load-bearing members 12 extend between the elevator car 14 and a counterweight 16, wrapped at least partially around a powered traction sheave 18 located at or near the bottom of the hoistway 46. Frictional engagement (i.e., traction) between the traction sheave 18 and load bearing member 12 enables the traction sheave 18 to move the load-bearing member 12 and therefore the attached elevator car 14.

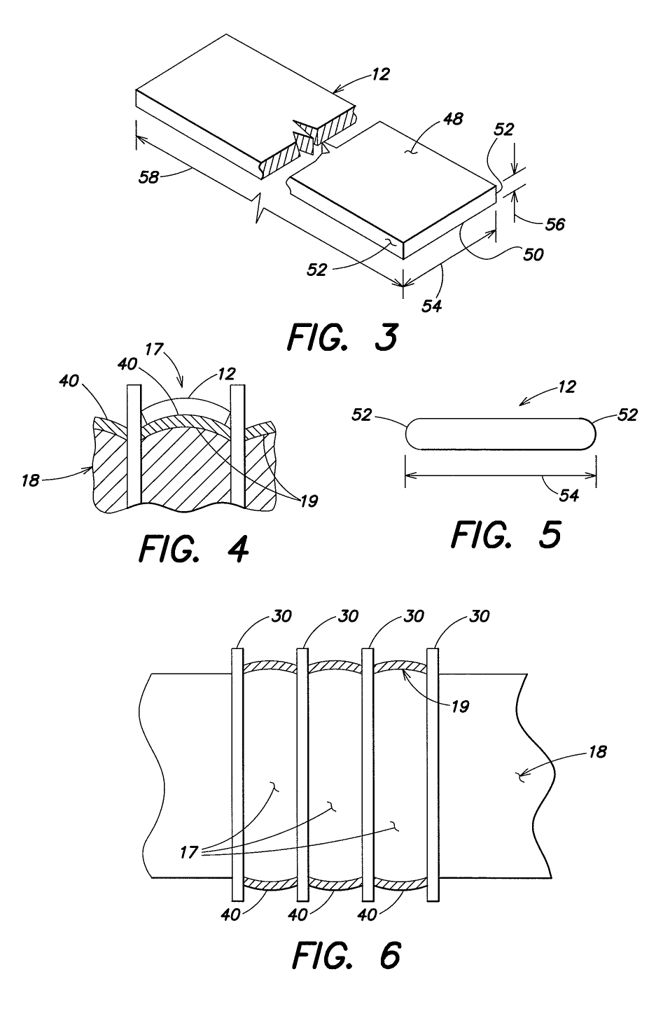

Now referring to FIG. 3, the load-bearing member 12 utilized in the above-described elevator systems has a first contact surface 48, a second contact surface 50, and longitudinal edges 52 extending between the first and second contact surfaces 48, 50. The first and second contact surfaces 48, 50 extend across the width 54 of the strip 12 and the longitudinal edges 52 extend across the thickness 56 of the strip 12. The width 54 and thickness 56 of the strip 12 are disposed in a cross-sectional plane that is perpendicular to the length 58 of the strip 12. The width 54 and thickness 56 are typically uniform through out substantially all of the length 58 of the strip 12, with the specific width and thickness chosen to suit the application at hand; e.g., the width 54 and the thickness 56 may be selected, along with the material of the load-bearing member 12 as will be discussed below, to meet a specified minimum breaking load requirement. The width 54 of the member 12 is typically in the range of 20-80 mm, and the thickness 56 is typically in the range of the 0.5-3.0 mm, although the width and thickness values may be outside these ranges for a given application. The difference in magnitude between the width 54 and the thickness 56 gives the member 12 significantly more flexibility in one direction than in the other; i.e., the minimum radius for touching the same contact surface 48, 50 together is significantly less that the minimum radius for touching the same longitudinal edge 52 together.

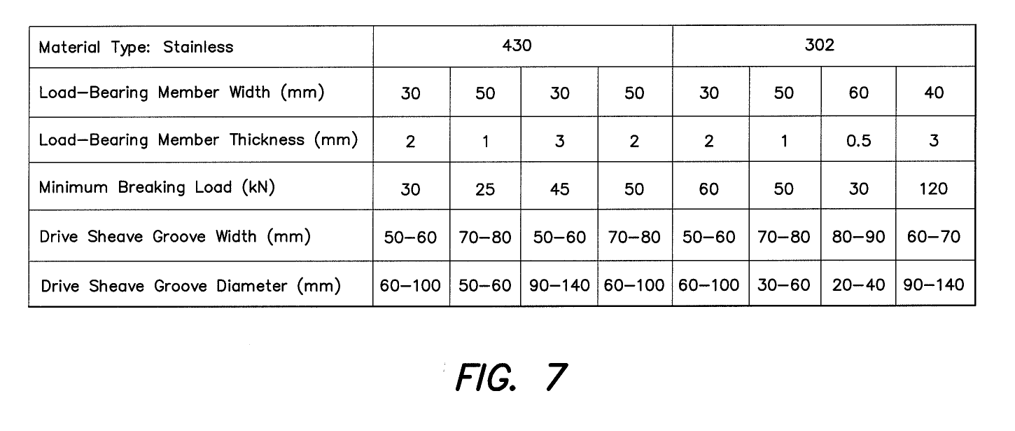

The member 12 is formed from a particular material that may be processed (e.g., hot rolled or cold rolled) to create desired mechanical properties; e.g., tensile strength, ductility, etc. Preferably, the load-bearing member 12 is comprised of a single solid material, which material is typically homogeneous throughout its cross-section. As will be discussed in detail below, the member 12 may be used with one or more sheaves 15, 18 each having a groove 17 with an arcuate profile 19. A crowned groove 17 causes the member 12 to bend across the width 54 of the member 12 as is diagrammatically shown in FIGS. 4 and 6; i.e., the member 12 becomes elastically curved across its width, bending about a lengthwise extending axis. In such elevator systems, the member 12 elastically accommodates such bending and is not, therefore, appreciably deformed by the aforesaid bending over the intended life span of the member 12. Materials possessing the requisite mechanical properties include ferritic and cold-worked austenitic stainless steels; e.g., the expected bending strains created by crowning are within the elastic region of ferritic and cold-worked austenitic stainless steels. Specific examples of acceptable member materials include type 302 and 430 stainless steel because of their relatively low or no hardening characteristics when subjected to frequent bending as would occur in an elevator system. FIG. 7 provides a table of load-bearing member 12 and drive sheave 18 parameters for exemplary embodiments. In addition to their ability to withstand bending stress, these stainless steel materials are also desirable because of their tensile strength and corrosion resistance. The tensile strength permits the member 12 to be used with a relatively thin cross-section discussed above. In those elevator systems utilizing a counterweight 16, the counterweight 16 is typically 45-50% heavier than elevator car 14 rated load capacity. The actual breaking strength requirement for the member 12 is a maximum of 55% of the car 14 maximum weight capacity. Thus, multiple thin elements 12 can be utilized. The thin cross-section of the member 12, in turn, permits the use of drive sheaves 18 having a very small diameter (e.g., in the range of 40-200 mm), relative to conventional drive sheaves (e.g., in the range of 100-1200 mm). A drive sheave 18 with a smaller diameter requires less power than one with a larger diameter. Building space requirements, cost, etc. all benefit from a smaller diameter drive sheave 18. The present invention load-bearing member 18 is not limited to the aforesaid stainless steel materials, however.

The longitudinal edges of the load-bearing member 12 may be prepared in a manner that minimizes stress concentrations, edge cracking, etc. to enhance the durability of the load-bearing member 12. In some embodiments, for example, the longitudinal edges may be formed by laser cut. Laser cutting certain materials into strip form creates a metallurgy with improved fatigue-resistance; e.g., decreased propensity to crack initiation. In some embodiments, the longitudinal edges 52 have an outwardly extending geometry that increases the overall width of the load-bearing member 12 (see FIG. 5). For example, the longitudinal edges 52 may be arcuately formed with a radius equal to one-half the thickness 56 of the load-bearing member 12. The longitudinal edge 52 geometry is not limited to a circular geometry, however, and may have a complex geometry that includes multiple curvatures.

Now referring to FIG. 6, a drive sheave 18 used within an elevator system can be integral with a motor 20 (e.g., see FIG. 1) or can be coupled to an independent motor 20. An acceptable drive sheave material is a medium carbon alloy steel sufficient for resistance to bending loads and for localized hardening. A specific example of an acceptable sheave material is AISI 4140. The sheave 18 includes a number of grooves 17, which number depends on the specific application at hand and the number of load-bearing members 12 utilized to support and/or move the car 14 and counterweight 16.

The surface of each groove 17 preferably has a surface roughness that is adequate to provide enhanced traction to the tension member 12, and localized hardening. Surface preparation techniques such as shot blasting or sand blasting, for example, prior to groove-localized hardening may be used to create an acceptable roughness (e.g., RA 128/256). The surface finish is typically applied to the groove surface regardless of whether the groove 17 is coated, because of the need to control the elevator car 14 in the event of a fire wherein a coating may be compromised. Localized hardening of the grooves 17 (e.g., to HRC 45-50) can be accomplished through techniques such as laser hardening, induction hardening, or flame hardening.

To keep the load-bearing members 12 in alignment and in their correct groove 17 positions, each groove 17 of the drive sheave 18 preferably has a positive profile 19 (also referred to as a “crown”). Depending on the load-bearing member 12 width and sheave 18 diameter, the crown 19 of each groove 17 may be a radius, for example, in the range of 200 mm to 800 mm. Utilizing crowned grooves 17 will subject the load-bearing members 12 to constant flexing and bending. The present invention load-bearing members 12, however, are selected to have mechanical properties that can accommodate the aforesaid flexing and bending (e.g., ferritic stainless steels, cold-worked austenitic stainless steels, etc.).

Groove spacers 30 may be provided between adjacent grooves 17 to inhibit or prevent undesirable load-bearing member 12 movement and noise generated through member-to-member contact. The groove spacers 30 can be an integral part of the machined shaft/sheave or can be a split-ring design. Acceptable materials for split-ring type groove spacers include Teflon or other similar, low-friction materials or coatings.

Because elevator systems 10 typically operate with different weights attached to each end of the load-bearing members, there are different elongation characteristics between lightly loaded and heavily loaded sides. These differences, side to side, are accommodated as the load-bearing members pass over the driving sheave 18. There is also continual relative motion between the drive sheave 18 and the load-bearing members, which is referred to as creep, and further relative motion caused by acceleration, deceleration, sudden stops, etc. The relative motion can cause wear on load-bearing members. To accommodate the relative motion, and thereby minimize the aforesaid wear, compliant, high friction coatings (or sleeves) 40 may be applied to the grooves 17 of the drive sheave 18.

The high friction materials of the coating/sleeve 40 helps to create adequate traction with load-bearing member 12, while at the same time providing desirable noise and vibration reduction. Such coatings/sleeves 40 can also act as a sacrificial wear member. Acceptable high friction materials include castable polyurethanes such as PPDI, ether-based MDI, and ether-based TDI. The coating/sleeve 40 can be adhesively bonded to the roughened groove surface 17. When such a coating sleeve 40 is worn, it can be replaced by removing the spacers 30 and sliding and bonding a new sleeve 40 into position. Where integral spacers 30 are used, worn coatings 40 can be cut and removed. New sheave coatings 40 can be adhesively bonded into position. Thermal polyurethane (TPU) sleeves are typically in the range of two to five millimeters thick.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention. For example, the above detailed description of the present invention provides examples of elevator system configurations as shown in FIGS. 1 and 2. The present invention is not, however, limited to these configurations.

What is claimed is:

1. A load-bearing member operable to be driven by a drive sheave in an elevator system, comprising:
a body defined by a thickness, a width that is greater than the thickness, and a length;
wherein the body comprises a single solid material, and is uniform in the cross-section, and is sufficiently flexible to permit the member to wrap at least partially around the drive sheave of an elevator system.

2. The load-bearing member of claim 1, wherein the single solid material is a ferritic stainless steel.

3. The load-bearing member of claim 2, wherein the single solid material is a type 430 ferritic stainless steel.

4. The load-bearing member of claim 3, wherein the type 430 ferritic stainless steel is cold-rolled.

5. The load-bearing member of claim 4, wherein the thickness of the member is in the range of about 0.5 mm to about 3.0 mm.

6. The load-bearing member of claim 5, wherein the longitudinal edges are formed by laser cut.

7. The load-bearing member of claim 1, wherein the single solid material is an austenitic stainless steel.

8. The load-bearing member of claim 7, wherein the single solid material is a type 302 austenitic stainless steel.

9. The load-bearing member of claim 8, wherein the type 302 austentic stainless steel is cold-rolled.

10. The load-bearing member of claim 9, wherein the thickness of the member is in the range of about 0.5 mm to about 3.0 mm.

11. The load-bearing member of claim 5, wherein the longitudinal edges are formed by laser cut.

12. The load-bearing member of claim 1, wherein the load-bearing member is flexible about a lengthwise extending centerline.

13. The load-bearing member of claim 1, wherein the single solid material is a homogenous stainless steel.

14. An elevator system, comprising:
a plurality of load-bearing members, each having a body defined by a thickness, a width that is greater than the thickness, and a length, and which body comprises a single solid material, and is uniform in the cross-section;
a car;
a counterweight;
a drive sheave;
wherein the load-bearing members connect the car and counterweight to the drive sheave, and are wrapped at least partially around the drive sheave.

15. The elevator system of claim 14, wherein the drive sheave includes a plurality of grooves formed from steel, and at least a portion of each groove is covered with a friction coating or sleeve.

16. The elevator system of claim 14, wherein the load-bearing member is comprised of stainless steel and the drive sheave includes a plurality of grooves formed from an alloy steel.

17. The elevator system of claim 16, where the alloy steel of the grooves is type AISI 4140 alloy steel.

18. The elevator system of claim 17, wherein the drive sheave grooves are crowned.

19. The elevator system of claim 18, wherein each groove has a surface roughness that is equal to or greater than RA 128.

20. The elevator system of claim 16, wherein the stainless steel is austenitic type 302 or ferritic type 430.

21. The elevator system of claim 14, further comprising:
a plurality of car support members for supporting the car within a hoistway; and
wherein the load-bearing members wrapped at least partially around the drive sheave are operable to provide motion to the car and the counterweight without supporting the car or counterweight within the hoistway.

22. The elevator system of claim 21, wherein each load-bearing member is comprised of stainless steel and the drive sheave includes a plurality of crowned grooves formed from an alloy steel.
